(19) United States
(12) Patent Application Publication
(10) Pub. No.: US 2008/0079995 A1
(43) Pub. Date: Apr. 3, 2008

(54) COMMUNICATION DEVICE, IMAGE PROCESSING DEVICE, AND METHOD OF SETTING RECIPIENT

(75) Inventors: Hiroyuki TSUJI, Kyoto (JP); Hideya Takenoshita, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/862,792

(22) Filed: Sep. 27, 2007

(30) Foreign Application Priority Data
Sep. 29, 2006 (JP) JP 2006-266752
Sep. 29, 2006 (JP) JP 2006-266753

(51) Int. Cl. G06F 3/12; H04N 1/04

(52) U.S. Cl. 358/1.15; 358/474

(57) ABSTRACT

A communication device of the present invention includes an reception unit that receives a request of a data transmission to a single or plurality of recipients, which is at least one external device, from a client, a transmitting unit that transmits data to the single or plurality of recipients, a storage unit that stores a single or plurality of recipient histories of a single or plurality of data transmissions performed by the transmitting unit, and a default setting unit that sets a single or plurality of default recipients of a data transmission based on the recipient histories.

### CROSS-REFERENCE TO RELATED APPLICATIONS

This application claims priority to Japanese Patent Application Nos. 2006-266753 (filed Sep. 29, 2006) and 2006-266752 (filed Sep. 29, 2006), which are hereby incorporated by reference in its entirety.

### BACKGROUND OF THE INVENTION

### Field of the Invention

The present invention relates to a communication device capable of transmitting data, an image processing device provided with the same, and a method for setting a single or plurality of recipients to which data is transmitted.

Improvements have been made in communication terminals that are allowed to transfer files (e.g., image files) so that users can easily specify a recipient to which a file is transferred. For example, Japan Patent Application Publication JP-A-2005-84981 (dated Mar. 31, 2005) discloses a plurality of communication terminals and a web server, all of which are connected to a network. The communication terminals have file transferring functions performed by means of the server message block (SMB), the file transfer protocol (FTP), and the like. On the other hand, the web server holds a browser list and a recipient list (browse list) in which information such as an address of the respective communication terminals is included.

The publication JP-A-2005-84981 describes the following operation flow diagram as a browsing operation that is performed when a communication terminal transfers a file to another communication terminal. First, a communication terminal accesses the web server and requests a browser list. If the communication terminal receives a response from the web server and obtains the browser list, it selects a browser for requesting a browse list from the browser list, and requests a browse list based on the name of the selected browser. The above described steps are repeatedly performed until the requested browsing list is obtained.

If the browse list is obtained by performing the above described steps, in other words, if a shared folder list is obtained and then a user selects a recipient from the shared folder list, the communication terminal from which a file is transmitted (i.e., source terminal) transfers a file to a communication terminal to which the file is transmitted (i.e., recipient terminal) based on the selection.

The publication JP-A-2005-84981 describes that the above described steps allow a file transfer to be performed without a user's input of a recipient. However, in the invention described in the publication, a user is required to select and to specify a recipient to which a file is transmitted from a recipient list. Accordingly, the user's burden is not necessarily reduced by the invention described in the publication.

### SUMMARY OF THE INVENTION

In view of the aforementioned hitherto known problem, it is an object of the present invention to provide an image processing device that is capable of reducing the user's burden in performing a data transmission.

A communication device in accordance with the present invention includes an reception unit that receives a request of a data transmission to a single or plurality of recipients, which is a single or plurality of external devices, from a client, a transmitting unit that transmits data to the recipients, a storage unit that stores a single or plurality of recipient histories of a single or plurality of data transmissions performed by the transmitting unit, and a default setting unit that sets a single or plurality of default recipients of a data transmission based on the recipient histories.

In addition, an image processing device in accordance with the present invention includes an image scanning unit that is capable of obtaining image data by scanning an image on a document, a reception unit that receives a data transmission request to a single or plurality of recipients, which is a single or plurality of external devices, from a client, a transmitting unit that is capable of transmitting the image data to the recipients, a storage unit that stores a single or plurality of recipient histories of a single or plurality of data transmissions performed by the transmitting unit, and a default setting unit that sets a single or plurality of default recipients of a data transmission based on the recipient histories.

Furthermore, a method for setting a single or plurality of recipients of a data transmission in accordance with the present invention includes the steps of storing a single or plurality of recipient histories of a single or plurality of past data transmissions, and setting a single or plurality of recipients based on the recipient histories.

### BRIEF DESCRIPTION OF THE DRAWINGS

FIG. 1 is a view of a block diagram illustrating a main configuration of a multifunction peripheral (or a multifunction device) according to an embodiment of the present invention.

FIG. 2 is a plan view illustrating a main configuration of an operation and display unit of the multifunction peripheral.

FIG. 3 is a view of a diagram illustrating a setting of a predetermined period.

FIG. 4 is a view of a flowchart illustrating an image transmission steps performed by the multifunction peripheral.

FIG. 5 is a view of a flowchart illustrating the image transmission steps performed when a single or plurality of recipients to which an image is transmitted is set based on a user's manual input.

FIG. 6 is a view of a flowchart illustrating the image transmission steps performed when a default setting of a single or plurality of recipients is completed.

FIG. 7 is a view of a screen shot of a recipient input screen displayed when the image transmission steps are performed by the multifunction peripheral.

FIG. 8 is a view of a screen shot of a confirmation screen displayed after a single or plurality of recipients is inputted in the image transmission steps performed by the multifunction peripheral.

FIG. 9 is a view of another example of a screen shot of a recipient input screen displayed when the image transmission steps are performed by the multifunction peripheral.

FIG. 10 is a view of a diagram illustrating an example of recipient histories of data transmissions.

FIG. 11 is a view of a flowchart illustrating another embodiment of the image transmission steps performed by the multifunction peripheral.

FIG. 12 is a view of a screen shot of an address book screen.

### DETAILED DESCRIPTION OF THE PREFERRED EMBODIMENTS

An embodiment of a communication device in accordance with the present invention will be hereinafter described with reference to the attached figures. Note that in the following embodiment, a communication device in accordance with the present invention is applied to an image processing device, but it is not limited to this. It is also possible to use the communication device as a device for transmitting data such as documents and sounds excluding images.

Also, a so-called multifunction peripheral (MFP) with functions of a printer, a copier, and a facsimile is exemplified as an image processing device in the following embodiment. However, the present invention is not limited to this. In other words, it is possible to change according to discretion a specific configuration of the MFP in accordance with the present embodiment so long as the MFP has a function of transmitting an image.

### First Embodiment

### Configuration of MFP 1

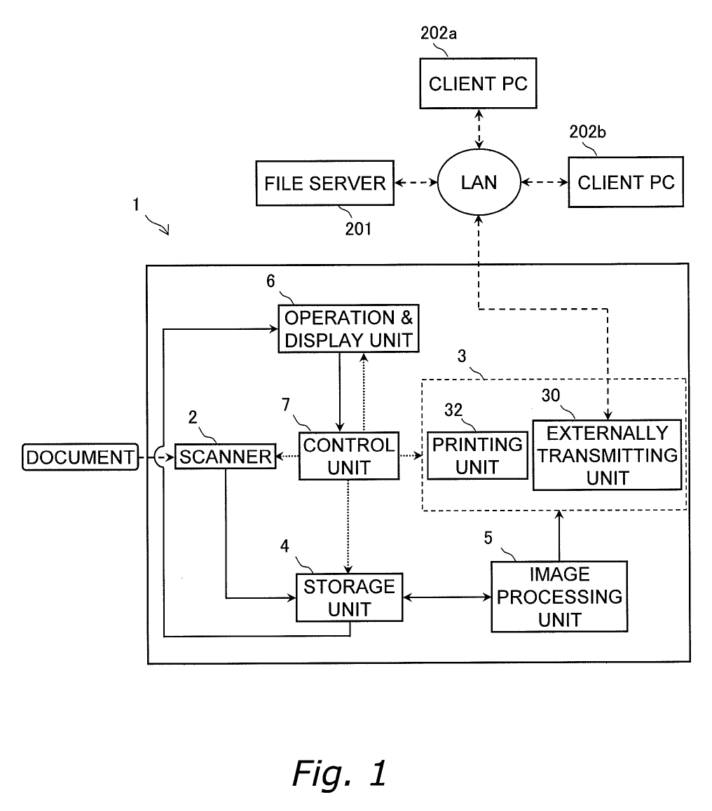

FIG. 1 is a view of a block diagram illustrating a main configuration of a multifunction peripheral (MFP) 1 according to an embodiment of the present invention. The MFP 1 includes a scanner 2, an output unit 3, a storage unit 4, an image processing unit 5, an operation and display unit 6, and a control unit 7. In addition, the output unit 3 includes an externally transmitting unit 30, a printing unit 32, and the like. Among these units, the output unit 3, the storage unit 4, and the control unit 7 function as a communication device.

The scanner 2 is an example of an image scanning unit that is capable of obtaining image data by scanning an image on a document. Specifically, the scanner 2 includes an image sensor such as a CCD, and further includes a unit such as an A/D converter for digitalizing an analog signal that is output from the image sensor. Accordingly, the scanner is capable of scanning an image on a document and obtaining the image data.

The storage unit 4 is capable of receiving and then storing the image data that the scanner 2 obtains and outputs. The storage unit 4 is capable of storing recipient histories of data transmissions from the externally transmitting unit 30. Here, the recipient histories are associated with the senders/source/clients of the data transmissions. The storage unit 4 may store at least a single or plurality of recipient histories within a predetermined period to be described, so that the control unit 7 is allowed to perform a default setting of a single or plurality of recipients. In other words, it does not necessarily store the recipient histories of all data transmissions. The recipient histories will be hereinafter described in detail. Note that a storage device such as a hard disk drive (HDD) may be used as the storage unit 4.

The image processing unit 5 converts the image data that is output from the storage 4 into image data to be transmitted (hereinafter called “transmission image data”), and transmits the converted data to the output unit 3.

The externally transmitting unit 30 may be any type of unit as long as it is capable of transmitting data to a single or plurality of external devices. Specifically, the externally transmitting unit 30 is capable of transmitting data to a file server 201, client PCs 202a and 202b, or the like through a LAN 200. Note that the file server 201 and the client PCs 202a and 202b are examples of external devices. Specifically, the externally transmitting unit 30 is capable of sharing/transferring a single or plurality of files with/to the file servers 201 and the client PCs (202a and 202b) by means of protocols such as the file transfer protocol (FTP) and the symmetric multiprocessing (SMP). In addition, the externally transmitting unit 30 is capable of sending an e-mail, a facsimile, and the like. In other words, it is possible to apply various types of communication devices such as a facsimile machine to the external device. The externally transmitting unit 30 includes a modem (modulator/demodulator), a terminal adapter (TA), and the like (not shown in the figure). It is capable of performing communication with a single or plurality of external machines through a communication link such as a telephone line, an integrated services digital network (ISDN) line, a wireless communication, a leased line or a cable television service (CATV) line, or a network such as a local area network (LAN), a wide area network (WAN), and the internet. Also, it is also capable of sending and receiving a facsimile in conformity with a regulation such as the Group 3 (G3) and the Group 4 (G4). Note that it is possible to change as needed the configuration of the externally transmitting unit 30 in accordance with the external device to which data is transmitted, and the configuration is not limited to the present embodiment. The printing unit 32 prints out image data on a sheet of paper. It is preferably possible to use a heretofore known image formation system such as an electrophotographic system and an ink jet system as the printing unit 32.

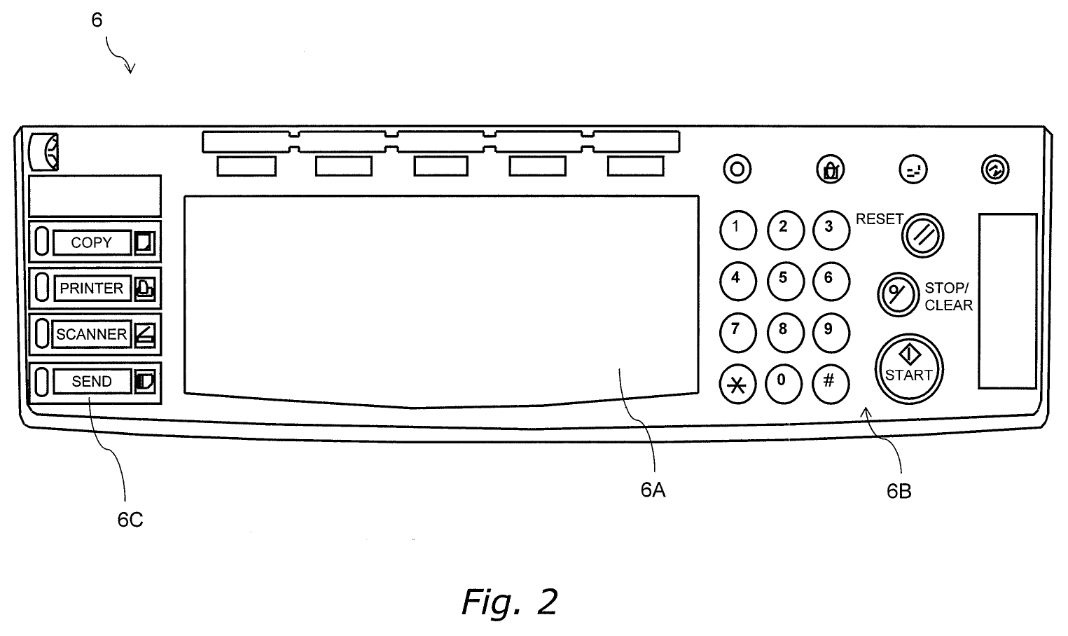

The operation and display unit 6 includes a display unit 6A such as a liquid crystal display (LCD), and a group of physical keys 6B including ten keys, a start key, a stop key, and a cancel key. It provides a user with a variety of information, and at the same time as this, receives a user's input (see FIG. 2). The group of physical keys 6B also includes a transmission function key 6C functioning as a function selection key. Note that the display unit 6A functions as a display unit, and simultaneously as a touch panel with touch sensors (not shown in the figure).

The control unit 7 sends/receives a data signal and a control signal to/from each of the units included in the MFP 1 in accordance with a request/instruction received from the outside through the operation and display unit 6 or the LAN 200, and thus comprehensively controls operational steps such as image processing steps and data transmission steps. Specifically, it is possible to make up the control unit 1 using a central processing unit (CPU), a read only memory (ROM), a random access memory (RAM), and the like. The CPU is capable of running programs by performing a variety of computations. The ROM stores control programs executed by the CPU, operational programs of the units included in the MFP 1, and the like. On the other hand, the RAM functions as a work area of the CPU, and also includes areas such as an area for storing contents of a user's input.

### Recipient Setting

Especially, the control unit 7 functions as a default setting unit for setting a single or plurality of default recipients. In other words, based on the content stored in the storage unit 4, the control unit 7 is capable of setting a single or plurality of recipients to which data are most frequently transmitted among recipients included in the recipient histories within a predetermined period to be the single or plurality of default recipients in a newly requested data transmission.

Thus, the single or plurality of recipients to which data are most frequently transmitted is set to be the single or plurality of default recipients. Accordingly, the need for a user to set a single or plurality of recipients will be reduced in a data transmission with the MFP 1. In addition, a single or plurality of recipients to which data are not frequently transmitted is not set to be the single or plurality of default recipients. Therefore, necessity that a user resets a single or plurality of recipients will be lowered. Furthermore, a single or plurality of recipients to which data are frequently transmitted is set to be the single or plurality of default recipients. Accordingly, a wrong transmission will be less likely happen by mistakenly selecting a single or plurality of recipients.

Especially, depending on users, a certain trend is often observed in a single or plurality of recipients to which an image scanned from a document is transmitted. This is related to the facts that a single or plurality of recipients specified by a user as the single or plurality of recipients to which image data scanned from a document are transmitted often corresponds to a user's own terminal, and the user constantly uses the same terminal in most of the cases. In addition, even in a case that a user transmits data to another terminal, he/she often transmits the data to his/her terminal for the purpose of duplicating data as the evidence that he/she certainly transmits the data to a single or plurality of desired recipients. In view of the trend, it is very useful for a user that a single or plurality of recipients to which data are most frequently transmitted is set to be the single or plurality of default recipients.

Note that the term “predetermined period” is not necessarily limited to a particular point of time. It is possible to set as desired the predetermined period to be any point of time in the past, depending on user's preference, trend of a single or plurality of recipients, usage of the MFP 1, and the like. For example, even if a single or plurality of recipients to which data are most frequently transmitted vary with time, it is possible to reflect adequately this variation towards the default setting, if the predetermined period is set to include the previous data transmission or set to be a period relatively close to the present time. Also, it is possible to set the predetermined period to be a period in which a certain trend of a single or plurality of recipients is observed (e.g., a season, a day of a week, and a first or half of a month).

Furthermore, it is possible to change as desired not only a point of time (or position) in the time axis where a predetermined period is set, but also duration (i.e., length) thereof. If duration of the predetermined period is changed, the number of data transmissions varies accordingly, which is considered in setting a recipient. Therefore, a trend of a single or plurality of recipients to be set will also vary. For example, if data transmissions are intensively performed to a specific recipient and substantially no data transmission is performed to other recipients, the need to reset a default recipient will be reduced because recipients to which data are not frequently transmitted are not set to be a default recipient by setting duration of the predetermined period to be long. On the other hand, if data transmission is performed to a variety of recipients, it is possible to cope with variation of a recipient trend by setting duration of the predetermined period to be short.

Note that duration of the “predetermined period” as well as position thereof in the time axis is not limited to any particular period. It is possible to change it as desired, depending on user's preference, variation of recipients, usage of the MFP 1, and the like. For example, it is preferable to lower the number of data transmissions included within the predetermined period in order to cope adequately with the variation of recipients. Note that it is preferable that the number of data transmissions included in the predetermined period is two or more in order to set more precisely the single or plurality of default recipients based on frequency of the data transmission.

Here, the term “predetermined period” may be used for expressing a constant time period or the constant number of data transmissions. In other words, “all yesterday” may be set as the time period, for instance, and a single or plurality of recipients to which data are most frequently transmitted among all the recipients included in recipient histories in the time period may be set to be the single or plurality of default recipients. Also, a single or plurality of recipients, to which data are most frequently transmitted among all the recipients included in recipient histories of the first N-th data transmissions performed since the MFP 1 is powered on yesterday, may be set to be the single or plurality of default recipients. It is preferable that “N” is set to be two or more positive integers. If N is set to be one, an operation performed by the MFP 1 is the same as that in a second embodiment of the present invention to be described in the following section B.

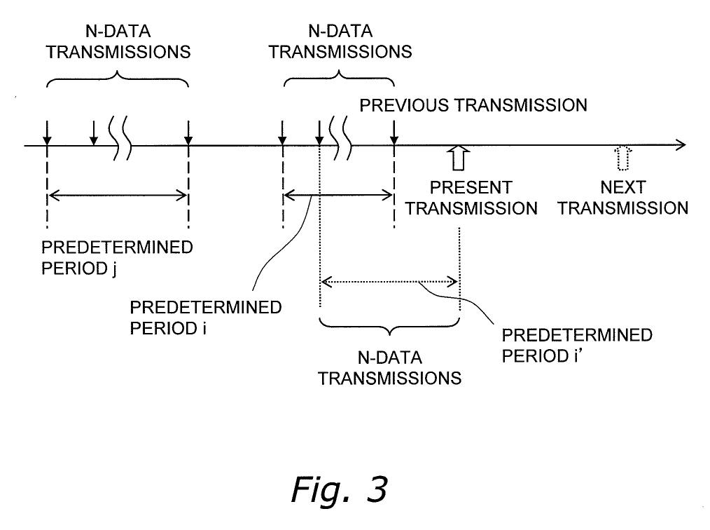

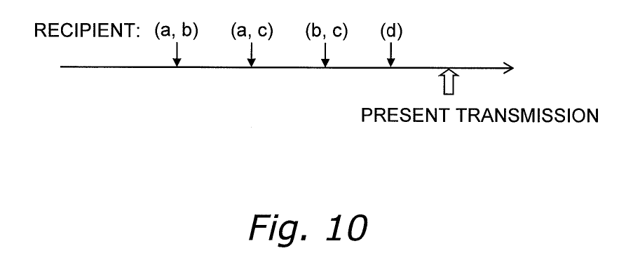

If the “predetermined period” is a period that includes N-data transmissions, it is preferable that the N-data transmissions are consecutively performed. FIG. 3 illustrates an example of a setting of the predetermined period. As illustrated in FIG. 3 and FIG. 10 to be described, an outline arrow indicates a present transmission (i.e., transmission to be performed this time), and black arrows indicate a previous transmission and transmissions performed earlier than the previous transmission. In addition, the dotted outline arrow indicates the next transmission. The control unit 7 may set the single or plurality of default recipients based on recipient histories of consecutive N-data transmissions including the previous data transmission (illustrated as predetermined period “i”), and may set it based on recipient histories of the past N-data transmissions not including the previous transmission. Especially, if the predetermined period i, that is, the most recent data transmission is considered in order to determine a recipient, it is possible to cope adequately with variations of a recipient trend.

Note that in the present embodiment, the term “the number of data transmissions” may be used not only for counting and expressing the number of recipients to which data are transmitted, but also for counting and expressing how many times some sort of data are transmitted to a single or plurality of recipients. In other words, when some sort of data is simultaneously transmitted to a plurality of recipients as well as when it is transmitted to a single recipient, “the number of data transmissions” is counted as one.

Furthermore, there are a plurality of recipients to which data are transmitted at the same frequency within the predetermined period, the control unit 7 is capable of setting a recipient included in a more recent recipient history among the plurality of recipients having the same data transmission frequency, in other words, a recipient to which data are more recently transmitted, to be the default (setting method 1). Thus, with the default setting, it is possible to cope more adequately with variations in a recipient trend.

Also, as described above, if a recipient to which data are more recently transmitted is set to be the default, there is a possibility that a file was simultaneously transmitted to a plurality of recipients having the same data transmission frequency. In other words, this is a case where the number of data transmissions performed to a plurality of recipients is the same, and the timing of the most recent data transmission performed to the plurality of recipients is also the same. Consequently, the storage unit 4 may be configured to store the order of receiving recipients in a single data transmission, and the control unit 7 may set a recipient that a user firstly input to be the default (setting method 2). This is because in a single data transmission, the recipient firstly inputted by a user is often considered to be the most important recipient for the user.

With reference to FIG. 10, this will be hereinafter described in detail. As illustrated in FIG. 10, files were transmitted to recipients “a” to “d” in the past, and the recipients are arranged in the chronological order of the recipient histories: (a, b), (a, c), (b, c), and (d). Note that a parenthesis “( )” in the figure corresponds to a single data transmission in which a single or plurality of recipients is simultaneously transmitted, and recipients included in the parenthesis are arranged from left to light in the chronological order of user' inputs. In other words, as to the earliest history of the four recipient histories, the recipient “a” and “b” were inputted in that order, and data were transmitted to these two recipients.

In an example of FIG. 10, the number of data transmissions performed to the recipients “a,” “b,” and “c” is the same, two. In addition, data were transmitted to the recipients “b” and “c” at the same time. Therefore, the default is not set even with the above setting method 1. Consequently, the control unit 7 sets the recipient “b” that was inputted earlier than the recipient “c” in the data transmission before the last data transmission to be the default recipient with the setting method 2.

Also, without the setting methods 1 and 2, the default setting may be performed by setting a recipient that a user more recently inputs among a plurality of recipients having the same data transmission frequency to be the default recipient (setting method 3). In the example of FIG. 10, the recipient “c” is set to be the default recipient with the setting method 3.

In addition, the default setting method of this kind may be used in the combination with other setting methods. For example, while the number of data transmissions does not reach N, the previous recipient may be set to be the default recipient. Then, when it reaches N, the default recipient may be set based on the data transmission frequency with respect to the recipients. To realize the above setting methods 1 to 3, the storage unit 4 is configured to store the order that a user inputs the recipients as well as the order that data are transmitted to the recipients.

In addition, in the present specification, the term “recipient” may be a facsimile number, a folder's location (e.g., URL), an e-mail address, a printer name or its installation site.

Also, the term “recipient histories” is not limited to histories of recipients to which data are normally transmitted (hereinafter called “to:” recipient), and may be histories of recipients to which data are transmitted by means of carbon copy (hereinafter called “cc:” recipient”). In the same manner, a single or plurality of “recipients” set by the control unit 7 is not limited to a single or plurality of “to:” recipients, and may be a single or plurality of “cc:” recipients.

In other words, the storage unit 4 is configured to store at least either of a single or plurality of “to:” recipients or a single or plurality of “cc:” recipients, and is preferably configured to store the both. To store the above two types of recipients, the storage unit 4 may store recipients with/without distinguishing between the “to:” recipient and the “cc:” recipients. If these recipient types are distinguished from each other, they may be stored separately and may be stored by associating each of the “to:” recipients with each of “cc:” recipients.

In the same manner, the control unit 7 is capable of setting the default of at least either of a single or plurality of “to:” recipients or a single or plurality of “cc:” recipients based on the recipient histories. For example, the control unit 7 may be configured to count all of the number of data transmissions performed with respect to the “to:” recipients and the “cc:” recipients, and to set a single or plurality of recipients to which data are most frequently transmitted to be the single or plurality of default recipients of a single or plurality of “to:” recipients based on the content stored in the storage unit 4.

When a user transmits data to a plurality of recipients, he/she may transmit the data to a specific recipient for the purpose of duplicating data as the evidence that he/she certainly has transmitted the data. In this case, a recipient to which data are transmitted for a duplication purpose may be inputted either as a “to:” recipient or a “cc:” recipient. When this default setting method is used, a recipient to which data are most frequently transmitted among the “to:” recipients and the “cc:” recipients is set to be the default recipient. Therefore, it is possible to prevent the data transmission performed to a specific recipient for a duplication purpose from being forgotten or from being failed to be done.

Furthermore, the control unit 7 may be configured to be capable of setting a single or plurality of default recipients of the “to:” recipients and the “cc:” recipients. When both types of default recipients are set, the control unit 7 may set a single or plurality of recipients to which data are most frequently transmitted among the recipients included in the “to:” recipient histories to be the single or plurality of default recipients of the “to:” recipients. On the other hand, independently from the default of the “to:” recipients, the control unit 7 may set a single or plurality of recipients to which data are most frequently transmitted among the “cc:” recipients included in the “cc:” recipient histories to be the single or plurality of default recipients of the “cc:” recipients. Also, the single or plurality of default recipients of the “to:” recipients may be set in the same manner, and then a single or plurality of recipients to which data were most frequently transmitted as one of the default “cc:” recipients of the “to:” recipients in the recipient histories may be set as the single or plurality of default recipients of the “cc:” recipients.

In the default setting methods with which the control unit 7 sets the single or plurality of default recipients of the “to:” recipients and the “cc:” recipients, a method, by which a single or plurality of default recipients of the two types are independently set, is preferred when different trends are observed for the “to:” recipients and the “cc:” recipients (e.g., regardless of the “to:” recipients, a file is always transmitted to a specific terminal such as a user's own terminal). On the other hand, a method for setting the “cc:” recipient in response to the “to:” recipient is preferable when a correlation is observed between the “to:” recipients and the “cc:” recipients (e.g., the following trend is observed: a recipient “B” is selected as one of the “cc:” recipients when data are transmitted to a recipient “A”).

Here, it is preferable that the “to:” recipient histories and the “cc:” recipient histories are resulted by counting the number of the “to:” recipients and that of the “cc:” recipients to which data are transmitted in the same “predetermined period,” but the two types of recipient histories may be resulted by counting the number of the two types of recipients to which data are transmitted in different predetermined periods.

### Example of Operation Performed in Image Transmission

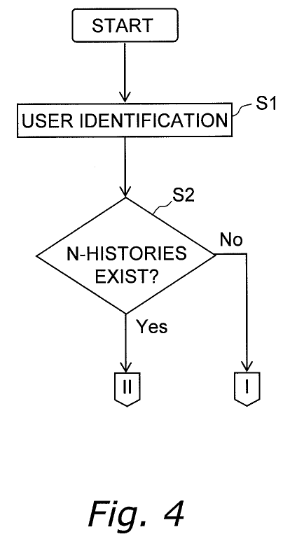

With reference to FIGS. 4 to 8, an example of processing steps, which are performed when the MFP 1 transmits an image to another device, will be hereinafter described in detail. In this example, the control unit 7 is configured to set a single or plurality of recipients to which data are most frequently transmitted among the recipients included in the past N-recipient histories including the previous data transmission to be the single or plurality of default recipients (see predetermined period i in FIG. 3). Note that N is two or more positive integers in the present example. The following are details of the processing steps.

FIGS. 4 to 6 are views of flowcharts illustrating the processing steps performed in data transmission.

As illustrated in FIG. 4, if a user selects a data transmission function through the operation and display unit 6, a series of steps are started as follows. First, the control unit 7 identifies a user (Step S1). Specifically, the control unit 7 instructs the display unit 6A to display a user confirmation screen. The user confirmation screen is a screen that receives a user name and a password inputted by a user. Based on these input contents, the control unit 7 identifies a user (i.e., a client/sender of data transmission). In addition, the information is also used for an authentication process between a file server and a client PC.

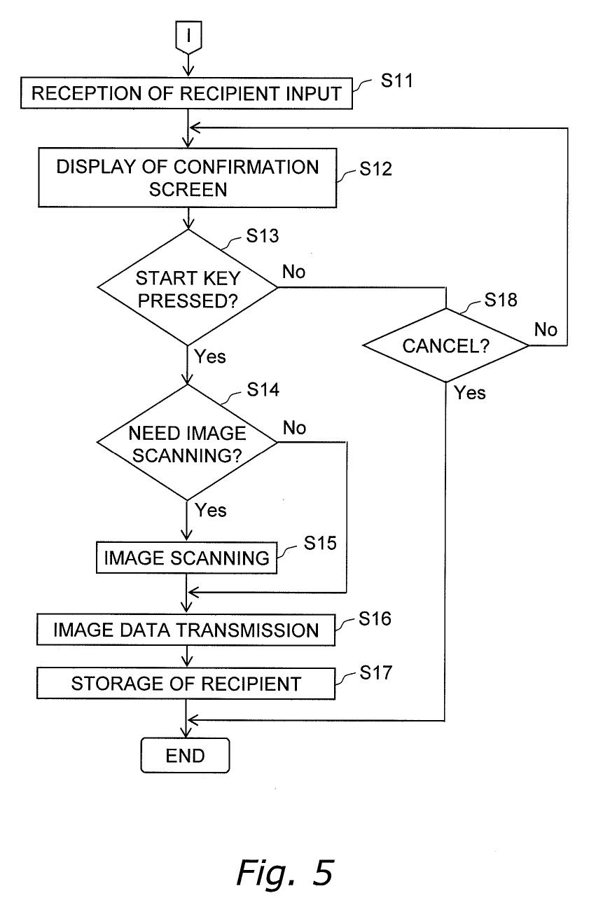

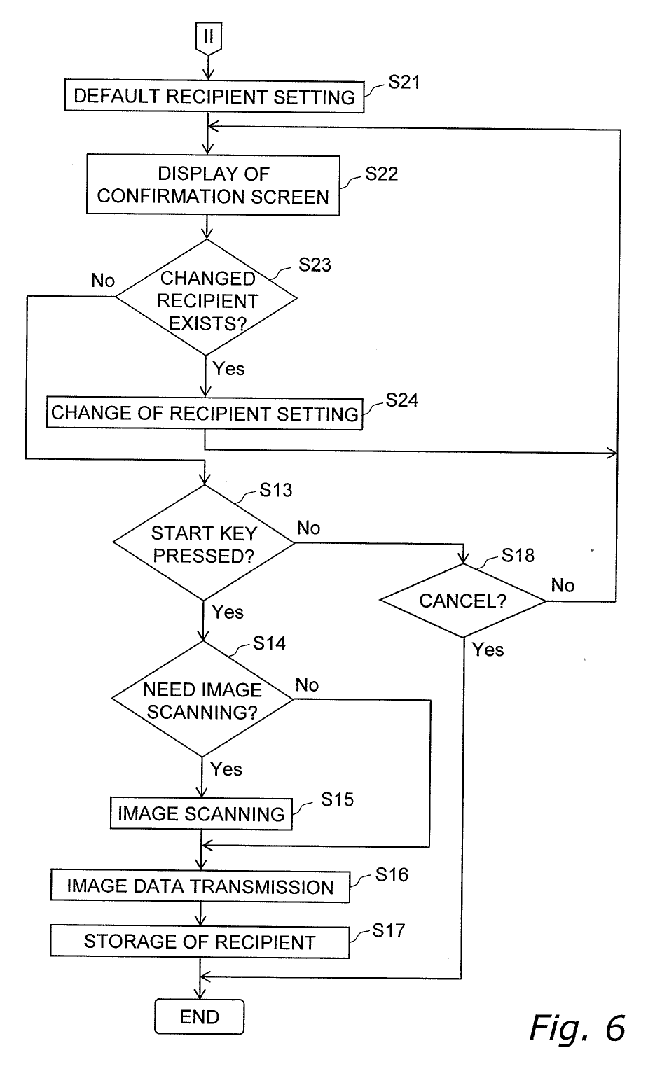

If the storage unit 4 does not store N-recipient histories (No in Step S2) or if a user manually inputs a recipient according to one's preference, processing steps “I” illustrated in FIG. 5 are performed. On the other hand, if the storage unit 4 stores N-recipient histories (Yes in Step S2) and the single or plurality of default recipients is/are set based on the recipient histories, the processing steps “II” illustrated in FIG. 6 are performed.

### Operational Steps Performed when Recipient is Manually Selected

In the operational steps, the control unit 7 receives a user's input of a recipient through the operation and display unit 6, and sets a recipient based on the received content (Step S11). In other words, the operation and display unit 6 functions as a reception unit.

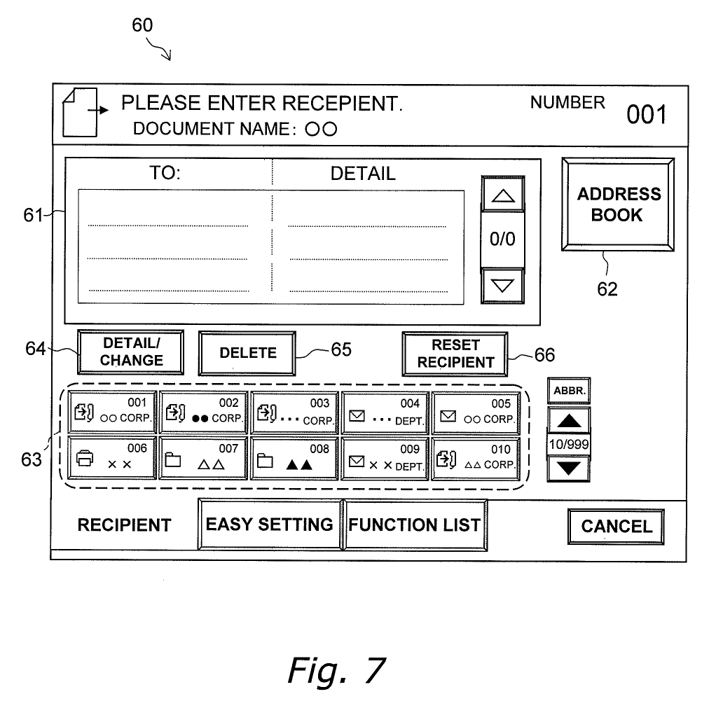

Specifically, a recipient input screen is displayed on the display 6A. The recipient input screen functions as a screen that receives user's input of a single or plurality of recipients to which image data is transmitted. FIG. 7 illustrates a recipient input screen 60 as an example of the recipient input screen. A recipient display field 61 for displaying recipients, an address book key 62, a group of abbreviated keys 63, a detail/change key 64, a delete key 65, a recipient reset key 66, and the like are displayed on the recipient input screen 60.

The recipient display field 61 remains blank until a user inputs a recipient (i.e., a single or plurality of “to:” recipients essentially, and a single or plurality of “cc:” recipients as needed). If a user presses the address book key 62, a recipient list preliminarily stored in the storage unit 4 is displayed on the display unit 6A. A user is capable of selecting a single or plurality of recipients from the list.

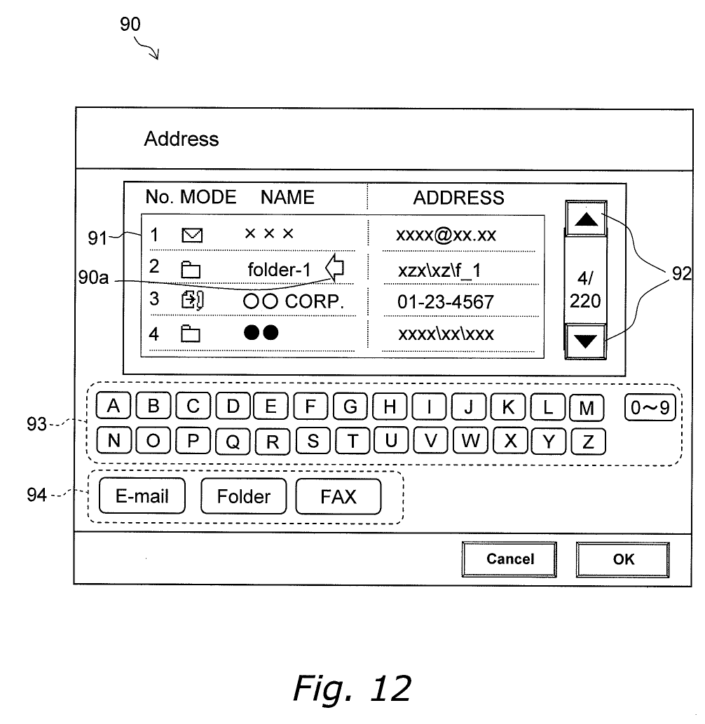

FIG. 12 shows an address book screen 90 as an example of a display screen of a recipient list. The address book screen 90 includes an address data display field 91, page keys 92, a group of search keys 93, mode keys 94, an OK key 95, and the like. The address data field 91 displays a list of addresses of recipients stored in the storage unit 4. If any specific instruction is not given by a user, different types of addresses, such as an e-mail address that is a recipient of an e-mail, a folder name that is a recipient of a file, and a telephone number that is a recipient of a facsimile, are displayed in the address data display field 91. Here, the recipient order displayed in the address data display field 91 is not limited to a particular order. However, in the present embodiment, recipients are displayed in the order of the memory number assigned to each of addresses.

In FIG. 12, if either of the page keys 92 is pressed, a page displayed in the address data display field 91 is turned back or forth under the control of the control unit 7. In other words, if either of the page keys 92 is pressed, a screen displayed in the address data display field 91 is changed so that addresses having larger or smaller memory numbers are allowed to be displayed in the address data display field 91. In addition, the group of search keys 93 includes keys corresponding to alphabets A to Z and numerals 0 to 9. If a key corresponding to an alphabet is pressed, some recipients with a name, an e-mail address, or a folder name whose initial corresponds to the pressed alphabet are displayed in the address data display field 91 under the control of the control unit 7. If a key corresponding to a numeral is pressed, some recipients with a name, an e-mail address, or a folder name whose initial corresponds to the pressed numeral are displayed in the address data display field 91 under the control of the control unit 7. In addition, the mode keys 94 include keys of “E-mail,” “Folder,” and “FAX.” If any of the mode keys 94 are pressed, the address data display field 91 is changed so that only the address data such as a e-mail address, a folder name, or a telephone number, which is associated with a mode assigned to the pressed mode key 94, is allowed to be displayed under the control of the control unit 7.

A cursor (or pointer) 90a is also displayed on the address book screen 90. The cursor 90a is configured to be moved depending on a user's contact location in the address data display field 91, which is detected by a touch sensor (not shown in the figure). If the OK key 95 is pressed, the control unit 7 sets an address that the cursor 90a points at the time when the OK key 95 is pressed to be a recipient.

In addition, the storage unit 4 is capable of storing recipients as abbreviated recipients. The recipients stored in the storage unit 4 as the abbreviated recipients are displayed as a group of abbreviated keys 63 on the screen. A user is also allowed to input a recipient by pressing the group of abbreviated keys 63.

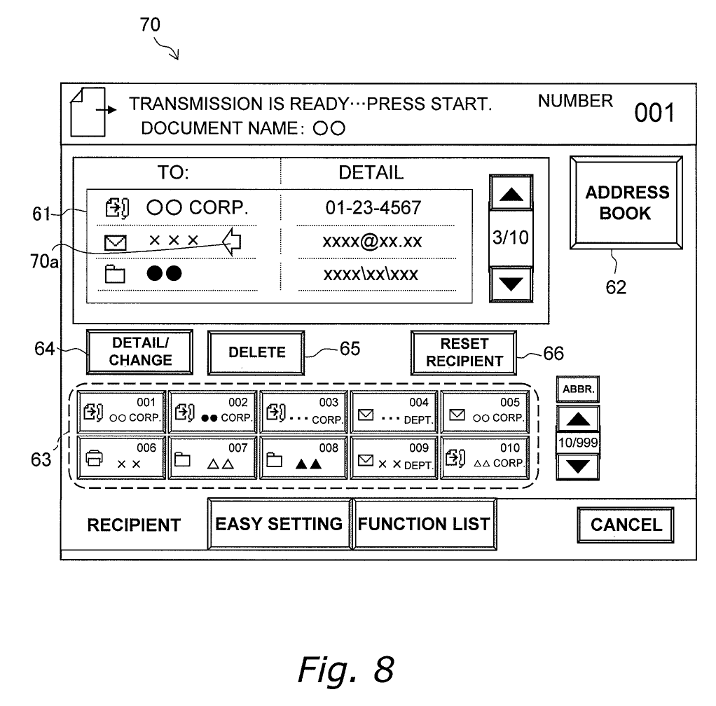

If an input of a recipient is completed, a confirmation screen 70 illustrated in FIG. 8 is displayed on the display unit 6A (Step S12), the MFP 1 will be allowed to receive an image transmission instruction. The confirmation screen 70 is substantially the same as the recipient input screen 60 except in that a recipient inputted in Step S11 is displayed in the recipient display field 61.

If the detail/change key 64 is pressed, the operation and display unit 6 is allowed to display details of recipients once inputted and to receive changes for the recipients. Specifically, a cursor 70a is displayed in the recipient display field 61. If the detail/change key 64 is pressed while the cursor 70a points to a recipient, the recipient to which the cursor 70a points is allowed to be changed. Then, if the address book key 62, any of the group of abbreviated keys 63, or any of ten keys are pressed, the control unit 7 changes the recipient that was once set according to the pressed key. Note that the cursor 70a is configured to be displayed on a user's contact location in the recipient display field 61.

Also, if the delete key 65 is pressed, the control unit 7 deletes a facsimile number, an e-mail address, a folder address, or the like, which was once set as a recipient. Also, if the recipient reset key 66 is pressed, recipients that have been set so far are all cleared, and a single or plurality of new recipients are allowed to be set. Every time an input is received for changing once inputted contents, contents of the confirmation screen 70 are updated and then a new confirmation screen 70 is displayed on the display unit 6A.

If a user puts a document on a platen/document glass (not shown in the figure) and then presses a start key included in the group of physical keys 6B, an image is scanned by the scanner 2 under the control of the control unit 7 (Steps S13 to S15).

Then, the transmitting image data are transmitted to the externally transmitting unit 30. Here, the transmitting image data are obtained in the course of a given processing performed by the scanner 2, the storage unit 4, and the image processing unit 5 under the control of the control unit 7. In a case that the image data are obtained by means of devices except the scanner 2, for example, in a case that the image data are received from an external PC through the LAN 200 or received from an external facsimile machine, an image scanning step (Step S15) is not performed when a transmission instruction is arbitrarily received from a user, and a suitable processing is performed as needed depending on circumstances.

Then, the externally transmitting unit 30 transmits the transmitting image data to a specified recipient under the control of the control unit 7 (Step S16). Here, the recipients are stored as the recipient histories in the storage 4 so that they correspond to user names, respectively (Step S17).

If the start key is not pressed in the above Step S13, the confirmation screen 70 continues to be displayed until an instruction for cancelling operational steps is received, in other words, until the stop key on the screen or the cancel key included in the group of the physical keys 6B is pressed. Then, if the instruction for cancelling the operational steps is received (Yes in Step S18), the operational steps are terminated without performing operational steps such as data transmission and storage of recipients.

### II Operation Performed when Default of Recipient is Set Based on Recipient History

Next, with reference to a flowchart illustrated in FIG. 6, operational steps will be hereinafter described in detail, which are performed by the MFP 1 after the transmission operational steps illustrated in FIG. 5 is performed N-times and then the recipient histories of the N-data transmissions are stored in the storage unit 4. Note that steps in the flowchart illustrated in FIG. 6, which correspond to those in the flowchart illustrated in FIG. 5, are given the same numerals as those in the flowchart illustrated in FIG. 5, and explanations thereof may be hereinafter omitted.

As described above, the control unit 7 identifies a user in Step S1. Then, based on the contents stored in the storage unit 4, it sets a single or plurality of recipients, to which data are most frequently transmitted in the user's recipient histories of the past N-data transmissions including the previous data transmission, to be the single or plurality of default recipients (Step S21).

The control unit 7 displays the confirmation screen 70 on the display unit 6A. Here, the single or plurality of default recipients is displayed in the recipient display field 61. Accordingly, it is possible to urge a user to confirm the recipient (Step S22). If a user inputs an instruction for changing the recipient through the confirmation screen 70, the control unit 7 changes the recipient in response to the instruction. Note that change of the recipient is performed as described above. In short, the control unit 7 not only sets a single or plurality of recipients but also functions as a recipient change unit for changing a single or plurality of recipients that was once set.

If a document is put on a platen and then the start key is pressed while a single or plurality of recipients is set, as described above, image on the document is scanned by the scanner 2 (Steps S13 to S15), and the transmitting image data are transmitted to the single or plurality of default recipients that is set in Step S21 or the single or plurality of recipients that is changed in Step S23 (Step S16).

The storage unit 4 stores a single or plurality of recipients to which data are transmitted in the present data transmission (Step S17). The control unit 7 sets the single or plurality of default recipients based on the recipient histories of N-data transmissions including the present data transmission (see predetermined period “i” in FIG. 3) in the next data transmission.

In this example, the control unit 7 is configured to set the single or plurality of default recipients by selecting a single or plurality of recipients from the recipient histories of N-data transmissions including the previous data transmission. Because of this, every time a data transmission is performed, the recipient histories of N-data transmissions are updated. Accordingly, even if the trend of the recipients to which a user wants to transmit data varies, it is possible to set automatically the single or plurality of default recipients in response to the variation. In other words, it is not necessary for a user to change the single or plurality of defaults by performing a further data input.

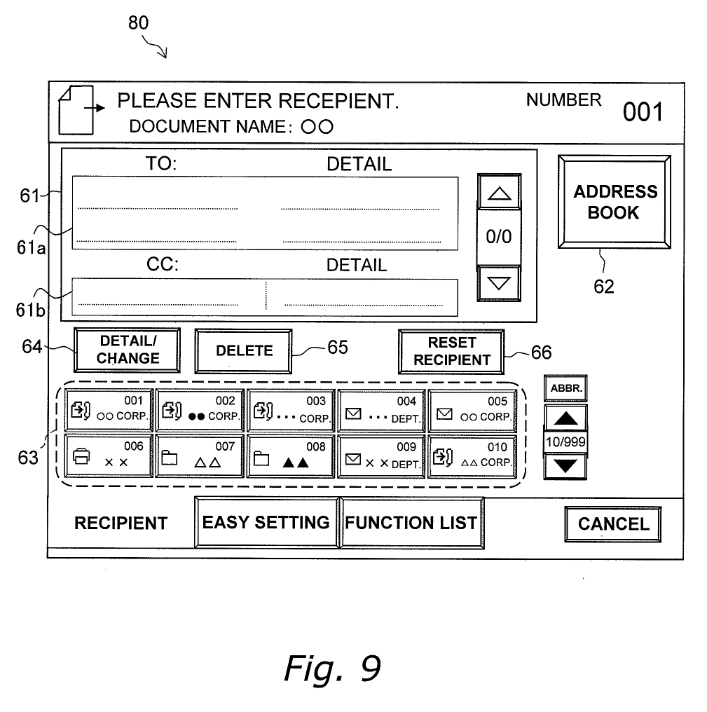

In addition, as illustrated in FIG. 9, the “to:” recipient display field 61a and the “cc:” recipient display field 61b may be provided in the recipient display field 61. Furthermore, as described above, it is possible to set the single or plurality of default “cc:” recipients as well as the single or plurality of default “to:” recipients.

Also, in the MFP 1, a predetermined key may be displayed on the display unit 6A, and an instruction for deleting all or a part of the recipient histories may be received when a user presses the key. It is possible to describe the MFP 1 in accordance with the present embodiment as the following sections (1) and (2).

(1) A communication device including a reception unit that receives a request for a data transmission to a single or plurality of recipients, which is a single or plurality of external devices, from a client, a transmitting unit that transmits data to the recipients, a storage unit that stores at least a single or plurality of recipient histories, which is associated with a single or plurality of clients of the data transmissions, of a single or plurality of data transmissions performed by the transmitting unit within a predetermined period, and a default setting unit that sets a single or plurality of recipients to which data are most frequently transmitted among recipients included in the recipient histories corresponding a client within a predetermined period to be a single or plurality of default recipients of a present data transmission when the present data transmission is requested by the client.

(2) An image processing device including an image scanning unit that is capable of scanning an image on a document, and a communication device according to the above section (1) in which the transmitting unit is capable of transmitting the image as the data.

With the above configuration described in the section (1), it is possible for the above communication device to set a single or plurality of recipients to which data are most frequently transmitted to be the single or plurality of default recipients in accordance with the past data transmissions performed by each client. Compared to random selection of recipients, the above default setting has a higher possibility that the single or plurality of default recipients corresponds to a single or plurality of recipients to which a client wishes to transmit data. Therefore, the need to reset a single or plurality of recipients will be lowered.

If an image scanned from a document is transmitted just like the image processing device according to the above section (2), a constant trend is often observed in a single or plurality of recipients to which data are transmitted depending on clients. In view of the trend, it is very useful for a user that a single or plurality of recipients to which data are frequently transmitted is set to be the single or plurality of defaults.

Also, as is clear from the above descriptions, the control unit 7 is capable of performing a method that includes a recipient history storing step (Step S17) for storing recipient histories of past data transmissions, and a recipient setting step (Step S21) for setting a single or plurality of recipients based on the above recipient histories.

### B. Second Embodiment

A MFP 1 of the second embodiment has the same configurations as those of the MFP 1 of the first embodiment except for the processing performed by the control unit 7. Therefore, the second embodiment will be hereinafter described below with reference to the same figures as those used in the first embodiment (i.e., FIGS. 1 and 2, and FIGS. 5 to 9). In addition, explanation of the members/units and processing, which are commonly used in the first and second embodiments, will be hereinafter omitted. In other words, the configurations described in the above section A will be applied to components/units and processing that are not hereinafter described.

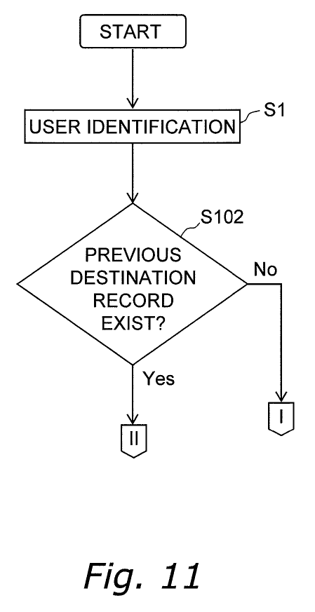

In the present embodiment, as illustrated in FIG. 11, the control unit 7 judges if the previous recipient is stored (Step S102) instead of performing Step S2 illustrated in FIG. 4. Here, if no history corresponding to a client of the present data transmission is stored (No in Step S102), processing steps I are performed. On the other hand, if a single or plurality of recipients, to which the client of the present data transmission requested to transmit data in the previous data transmission, is stored in the storage unit 4 (Yes in Step S102), processing steps II are performed.

In the present embodiment, the processing steps I are substantially the same as the processing steps described in the above section A. However, the processing steps of the present embodiment are different from those of the first embodiment in that at least a single or plurality of recipients of the present data transmission, which are associated with a client, may be stored in the storage unit 4 in Step S17. In other words, when the single or plurality of recipients is stored in Step S17, recordings of the recipients of the past data transmissions excluding the previous data transmission may be deleted. Also, a single or plurality of “recipients” in the present embodiment may be a single or plurality of “to:” recipients or a single or plurality of “cc:” recipients. In other words, in the present embodiment, the storage unit 4 may be configured to store at least either of a single or plurality of “to:” recipients or a single or plurality of “cc:” recipients of the previous data transmission in Step S17.

Also, in the present embodiment, the processing steps II are substantially the same as the processing steps described in the above section A. However, the processing steps of the present embodiment are different from those of the first embodiment in that a single or plurality of recipients of the previous data transmission is set to be the single or plurality of default recipients.

Thus, the single or plurality of recipients of the previous data transmission is set to be the single or plurality of recipient defaults of the present data transmission, and accordingly the need for a user to set a single or plurality of recipients will be reduced in data transmission performed by the MFP 1. In addition, a single or plurality of recipients to which data have not been transmitted is not set to be the single or plurality of default recipients. Therefore, the need for a user to reset a single or plurality of recipients will be lowered, and data transmission to a single or plurality of wrong recipients will be less likely to happen.

Especially, depending on users, a certain trend is often observed in a single or plurality of recipients to which an image scanned from a document is transmitted. Therefore, if a single or plurality of recipients of the previous data transmission is set to be a single or plurality of default recipients, a possibility will be higher that the single or plurality of default recipients corresponds to a single or plurality of user's desired recipients. If the single or plurality of default recipients corresponds to the single or plurality of user's desired recipients, the user does not have to input a single or plurality of recipients. Accordingly, this is very convenient for the user.

Note that the control unit 7 is capable of setting at least either of a single or plurality of default “to:” recipients and a single or plurality of default “cc:” recipients based on the recipient histories. For example, the control unit 7 may be configured to set a single or plurality of “to:” recipients of the previous data transmission stored in the storage unit 4 to be the single or plurality of default recipients of the single or plurality of “to:” recipients of the present data transmission, and prompt a user to input a single or plurality of “cc:” recipients as needed without setting the single or plurality of default “cc:” recipients. Also, the control unit 7 may be configured to set a single or plurality of “to:” recipients of the previous data transmission to be the single or plurality of default “to:” recipients of the present data transmission, and further set a single or plurality of “cc:” recipients of the previous data transmission to the single or plurality of default “cc:” recipients of the present data transmission. On the contrary, the control unit 7 may be configured to set only a single or plurality of “cc:” recipients and prompt a user to input a single or plurality of “to:” recipients.

Note that if the previous data transmission is performed with respect to a plurality of the “to:” recipients, all the “to:” recipients may be set to be the defaults. This is also true of a plurality of “cc:” recipients. In this case, as to the previous data transmission, for instance, recipients “a,” “b,” and “c” are set to be the “to:” recipients, and recipients “d” and “f” are set to the “cc:” recipients. Here, the recipients “a,” “b,” and “c” are set to be the default “to:” recipients of the present data transmission, and the recipients “d” and “f” are set to be the default “cc:” recipients.

In addition, as described in the setting methods in sections (2) and (3) of the section A, the single or plurality of default recipients is allowed to be set depending on the order of inputting recipients. In other words, in the above example, if recipients “a,” “b,” and “c” are inputted as the “to:” recipients in that order, the recipient “a,” which is inputted first, may be set to be the default recipient, or the recipient “c,” which is inputted last, may be set to be the default recipient. It is possible to describe the MFP 1 in accordance with the present embodiment as the following sections (3) and (4).

(3) The communication device including a transmitting unit that transmits data to a recipient that is an external device, and a recipient setting unit that sets a single or plurality of recipients in the previous data transmission requested by a client to be a single or plurality of default recipients of a present data transmission if the present data transmission is requested by the client.

(4) An image processing device including an image scanning unit that is capable of scanning an image on a document, and a communication unit according to the above section (3) in which the transmitting unit is capable of transmitting the image as the data.

With the configuration of the above section (3), the communication device is allowed to set a single or plurality of recipients of the previous data transmission to be the single or plurality of default recipients of the present data transmission in accordance with the past data transmissions performed by clients, respectively. Compared to random selection of recipients, the above default setting has a higher possibility that the single or plurality of default recipients corresponds to a single or plurality of recipients that a client wishes to set. Therefore, the need to reset a single or plurality of recipients will be lowered.

If an image scanned from a document is transmitted in the similar way as the image processing device according to the above section (3), a constant trend is often observed in a single or plurality of recipients to which data is transmitted depending on clients. In view of the trend, it is very useful for a user that a single or plurality of recipients of the previous data transmission is/are set to be the single or plurality of default recipients.

It should be understood that configurations obtained by the combination of the heretofore known art and the configurations described in the above first and second embodiments are also included within the technical scope of the present invention.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A communication device, comprising:
a reception unit being configured to receive a request of a data transmission to a single or plurality of recipients from a client;
a transmitting unit being configured to transmit data to the single or plurality of recipients;
a storage unit being configured to store a single or plurality of recipient histories of a single or plurality of data transmissions performed by the transmitting unit; and
a default setting unit being configured to set a single or plurality of default recipients of the data transmissions based on the recipient histories.

2. The communication device according to claim 1, wherein
the storage unit is configured to store the recipient histories of the data transmissions performed by the transmitting unit, and the recipient histories are associated with clients of the data transmissions, and
the default setting unit is configured to set a single or plurality of recipients to which data are most frequently transmitted to be a single or plurality of default recipients of a data transmission based on the recipient histories corresponding to a client when the data transmission is requested by the client.

3. The communication device according to claim 2, wherein
when the recipient histories corresponding to the same client include two or more recipients to which the data transmissions are most frequently performed and the same number of the data transmissions are performed, the default setting unit is configured to set a single or plurality of recipients to which data are more recently transmitted to be a single or plurality of default recipients.

4. The communication device according to claim 3, wherein
when the recipient histories corresponding to the same client include two or more recipients to which the data transmissions are most frequently performed and the same number of the data transmissions are performed and the last data transmission is performed at the same time, the default setting unit is configured to set a recipient inputted earlier than the rest of the two or more recipients in the last data transmission to be the default recipient.

5. The communication device according to claim 3, wherein
when the recipient histories corresponding to the same client include two or more recipients to which the data transmissions are most frequently performed and the same number of data transmissions are performed and the last data transmission is performed at the same time, the default setting unit is configured to set a recipient inputted later than the rest of the two or more recipients in the last data transmission to be the default recipient.

6. The communication device according to claim 1, wherein
the storage unit is configured to store the recipient histories of the data transmissions performed by the transmitting unit, the recipient histories associated with clients of the data transmissions, and
the default setting unit is configured to set a single or plurality of recipients of the previous data transmission requested by a client to be a single or plurality of default recipients of a data transmission when the data transmission is requested by the client.

7. The communication device according to claim 1, further comprising
a display unit configured to display a screen, the screen configured to receive a request to change the single or plurality of default recipients, and
a recipient change unit configured to change the single or plurality of default recipients to a single or plurality of other recipients depending on the request of changing default recipients received through the screen.

8. An image processing device, comprising:
an image scanning unit being configured to obtain image data by scanning an image on a document;
a reception unit being configured to receive a request of a data transmission to a single or plurality of recipients from a client;
a storage unit being configured to store a single or plurality of recipient histories of a single or plurality of data transmissions performed by the transmitting unit; and
a default setting unit being configured to set a single or plurality of default recipients of the data transmissions based on the recipient histories.

9. The image processing device according to claim 8, wherein
the storage unit is configured to store the recipient histories of the data transmissions performed by the transmitting unit, and the recipient histories are associated with clients of the data transmissions, and
the default setting unit is configured to set a single or plurality of recipients to which data are most frequently transmitted to be a single or plurality of default recipients of a data transmission based on the recipient histories corresponding to a client when the data transmission is requested by the client.

10. The image processing device according to claim 8, wherein
the storage unit is configured to store the recipient histories of the data transmissions performed by the transmitting unit, and the recipient histories are associated with clients of the data transmissions, and
the default setting unit is configured to set a single or plurality of recipients of the previous data transmission requested by a client to be a single or plurality of default recipients of a data transmission when the data transmission is requested by the client.

11. The image processing device according to claim 9, further comprising
a display unit configured to display a screen through which a request to change the single or plurality of default recipients is received, and
a recipient change unit configured to change the single or plurality of default recipients to a single or plurality of other recipients depending on the request of changing the default recipients received through the screen.

12. A method for setting a single or plurality of recipients of a data transmission, comprising:
storing a single or plurality of recipient histories of a single or plurality of past data transmissions; and
setting a single or plurality of recipients based on the recipient histories.

13. The method according to claim 12, wherein
storing the recipient histories includes storing the recipient histories of the past data transmissions, and associating the recipient histories with clients that request the past data transmissions, respectively, and
setting the single or plurality of recipients includes setting a single or plurality of recipients to which data are most frequently transmitted to be a single or plurality of recipients of a present data transmission based on the recipient histories corresponding to a client requesting the present data transmission.

14. The method according to claim 12, wherein
storing the recipient histories includes storing the recipient histories of the past data transmissions, and associating the recipient histories with clients that request the past data transmissions, respectively, and
setting the single or plurality of recipients includes setting a single or plurality of recipients included in the most recent recipient history among the recipients corresponding to a client requesting a present data transmission to be the recipients of the present data transmission.
